(19) United States
(12) Patent Application Publication
(10) Pub. No.: US 2010/0031251 A1
(43) Pub. Date: Feb. 4, 2010

(54) METHOD AND APPARATUS OF SOFTWARE MIGRATION

(76) Inventor: WEI-LING HSIEH, (US)

Correspondence Address: SQUIRE, SANDERS & DEMPSEY L.L.P., 1 MARITIME PLAZA, SUITE 300, SAN FRANCISCO, CA, 94111, US

(21) Appl. No.: 12/277,128

(22) Filed: Nov. 24, 2008

(30) Foreign Application Priority Data
Aug. 4, 2008 (CN) 200810117732.3

(51) Int. Cl. G06F 9/445

(52) U.S. Cl. 717/175

(57) ABSTRACT

The present invention relates to a method and apparatus of software migration. The method for software migration includes: generating software profile, the software profile comprises file layout, registry information and environment variable settings; copying the file layout to corresponding folders, setting the registry information and the environment variable settings according to the software profile, so as to achieve software migration. The method and apparatus for software migration mentioned above better realizes the software on the old computer or external storage devices can be migrated to the new computer or external storage devices when the old computer or external storage devices will be replaced or eliminated, which avoids the expenses for purchasing new software and bring convenience to users because the software needs not to be installed.

### CROSS-REFERENCE TO RELATED APPLICATIONS

This application claims priority to Chinese Patent Application No. 200810117732.3, filed on Aug. 4, 2008, entitled “A METHOD AND APPARATUS OF SOFTWARE MIGRATION”, which is incorporated herein by reference in its entirety.

### FIELD OF THE TECHNOLOGY

The present invention relates to virtualization technology field, and particularly to a method and apparatus of software migration.

### BACKGROUND OF THE INVENTION

Computerized office greatly facilitates the work and life of human. People perform their works by using computers in their office, and continue to perform the corresponding works by using the computers in other offices. For example, through mobile storage devices, users can carry files that have not been finished at the office to a computer which can operate the files at home. Without mobile storage devices, users must carry laptops in which the work content is stored to perform the corresponding work at any time.

In work and life, in order to keep the content of the corresponding work performed in consistent environment, the laptops in which the work environment and work content are stored will be carried so as to implement the work content. But this manner increases the travel burden of people, which brings inconvenience to the travel. The copy manner can achieve data migration, but an urgent problem is how to assure the different computers used by people have installed the needed software to support their work. When replacing computers, the software installed in the old computers needs to be migrated to new computers or to external storage devices. The migration method in prior art is achieved by installing compact disks.

However, if the original compact disks have been lost, these pieces of software will be unable to install again without buying new copies, therefore, the software migration will not be achieved. Additionally, the process of installing software often modifies the registry system and environment variables of the operating system, which is unable to be achieved by copying files directly. Therefore, software migration is very difficult.

### SUMMARY OF THE INVENTION

An embodiment of the present invention provides a method and apparatus of software migration, to realize that software on old computers can be migrated to new computers when old computers will be replaced or be eliminated, which avoids the expense for purchasing new software and brings convenience to users because software needs not to be installed.

An embodiment of the present invention provides a method of software migration. The method includes:

generating software profile, the software profile includes file layout, registry information and environment variable settings;

copying file layout to corresponding folders, setting the registry and the environment variable settings according to the software profile, so as to achieve software migration.

An embodiment of the present invention provides an apparatus of software migration. The apparatus includes:

a generating unit adapted to generate software profile, the software profile includes file layout, registry information and environment variable settings;

a migrating unit adapted to copy the file layout to corresponding folders, set the registry and the environment variable settings according to the software profile, so as to achieve software migration.

The method and apparatus of software migration mentioned above better realize that installed software can be migrated to other computers or external storage devices when old computers or external storage devices will be replaced or eliminated, which avoids the expense for purchasing new software and bring convenience to users because software needs not to be installed.

The present invention will be described in more detail with references to the drawings and embodiments.

### BRIEF DESCRIPTION OF THE DRAWINGS

FIG. 1 is a flow chart of an embodiment of the method for software migration of the present invention;

FIG. 2 is a schematic view of the position of virtual environment in the embodiment of the method for software migration of the present invention;

FIG. 3 is a flow chart of an embodiment of the method for office software migration of the present invention; and

FIG. 4 is a structure view of an embodiment of the apparatus for software migration of the present invention.

### DETAILED DESCRIPTION OF THE PREFERRED EMBODIMENTS

The embodiment of the method for software migration of the present invention includes:

generating software profile, the software profile includes file layout, registry information, and environment variable settings;

copying file layout to corresponding folders, setting the registry system and environment variable settings according to the software profile, so as to achieve software migration.

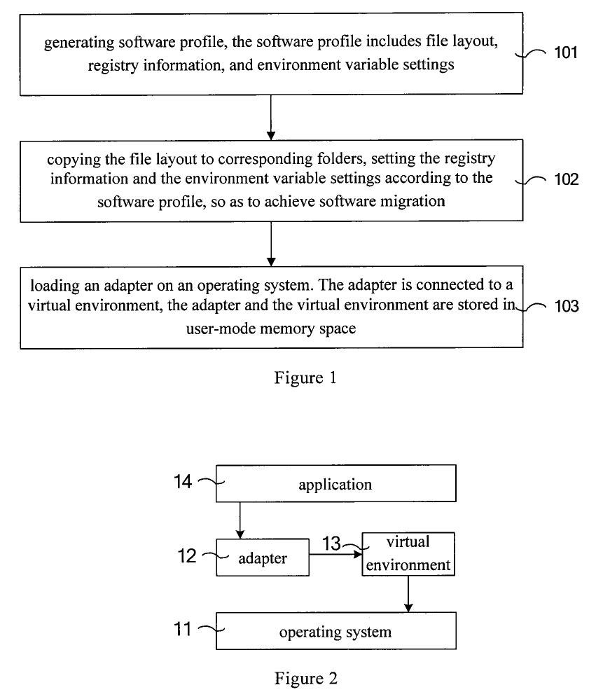

FIG. 1 is a flow chart of an embodiment of the method for software migration of the present invention, the method includes:

Step 101, generating software profile, the software profile includes file layout, registry information, and environment variable settings;

The software profile is created by analyzing the changes of the computer during the installation of software. The software profile mentioned above may include file layout, registry information, environment variable settings, and so on;

There are several methods for generating software profile, such as any one of the following three kinds of methods may be employed:

(1) dynamic analysis method: running a capturing tool at first to monitor the operation of the system, then installing software and making the capturing tool record the modification of the system made by the installation software, and recording the modification into the software profile;

(2) difference analysis method: taking snapshots of the system before and after the software is installed, comparing difference between the snapshots, and generating the software profile;

(3) static analysis method: many pieces of software exist in the format of Microsoft installation (MSI )file, which is an open format. MSI file describes every operation of the installation. The software profile may be generated according to the data in the MSI file.

The third method extracts the data directly from the open format of MSI files; therefore, this method is better among the three generating methods;

Step 102, copying the file layout to corresponding folders, setting the registry information and modifying the environment variable settings according to the software profile, so as to achieve software migration.

During the process of performing software migration, file layout should be copied to corresponding folders according to the above software profile, the registry information and environment variable settings should be modified as well.

Step 103, loading an adapter on an operating system. The adapter is connected to a virtual environment, and the adapter and the virtual environment are stored in user-mode memory space.

This step is optional. After the software migration is achieved, the adapter 12 needs to be loaded on the operating system 11 if the migrated software can not be run on the new computer or devices. The adapter 12 is connected to the virtual environment 13. As shown in the FIG. 2, the adapter 12 and the virtual environment 13 are stored in user-mode memory space. That is, any operation will pass the virtual environment 13 before being sent to the operating system 11. The virtual environment 13 may modify the operation of the application 14 to conform to the current situation.

The method for software migration mentioned above better realizes that, through generating software profile when the software is installed and representing these changes on another computer or external storage devices according to the software profile, the software on the old computer or external storage devices can be migrated to the new computer or external storage devices when the old computer or external storage devices will be replaced or eliminated, which avoids the expense for purchasing new software and brings convenience to users because the software need not to be installed.

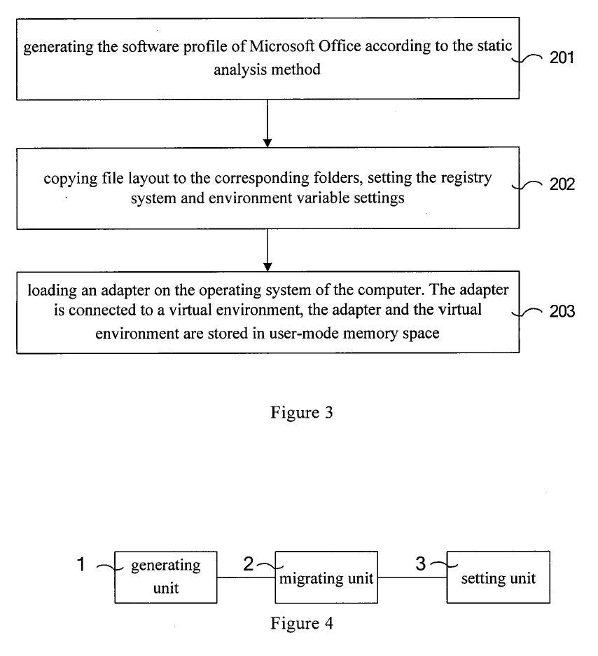

FIG. 3 is a flow chart of an embodiment of the method for office software migration of the present invention. As the new computer has not installed Microsoft Office, in order to view the word document on the computer, Microsoft Office (hereafter, Office) needs to be migrated by using an universal serial bus (USB) disc to this computer, the migration method includes:

Step 201, generating the software profile of Office according to the static analysis method;

The software profile of Office may be generated using dynamic analysis method or difference analysis method. The profile includes information about installation process, i.e., correspondence of files, the modification to the registry system, and the modification to the environment variables, and so on. For example, the original path is %APPDATA%\Microsoft\MSN Messenger, the current path is $DataDir$\Microsoft\MSN Messenger;

Step 202, copying file layout to the corresponding folders, setting the registry system and environment variable settings. For example, all content under the path of “%APPDATA%\Microsoft\MSN Messenger” is copied to the path of “$DataDir$\Microsoft\MSN Messenger”.

Step 203, loading an adapter on the operating system of the computer. The adapter is connected to a virtual environment, and the adapter and the virtual environment are stored in user-mode memory space.

After Office is migrated to the computer, an adapter is loaded on the operating system of the computer. The adapter is connected to a virtual environment, and the adapter and the virtual environment are stored in user-mode memory space. That is, any operation will pass the virtual environment before being sent to the operating system. The virtual environment may modify the operation of the application to conform to the current situation.

The above method for software migration generates the software profile according to the MSI file and represents these changes on the new computer according to the software profile, and further better realizes that the software on the USB drive can be migrated to the new computer, which avoids the expense for purchasing new software and brings convenience to users because Office needs not to be installed.

FIG. 4 is a structure view of an embodiment of the apparatus for software migration of the present invention, the apparatus includes: generating unit 1 adapted to generate a software profile, the software profile includes file layout, registry information and environment variable settings; migrating unit 2 adapted to copy file layout to corresponding folders, the registry information and the environment variable settings are set according to the software profile, so as to achieve software migration.

Additionally, in order to make software run in new computers or external storage devices after the software have been migrated, the above software migration apparatus may further include: setting unit 3 adapted to load an adapter on an operating system, the adapter is connected to a virtual environment, the adapter and the virtual environment are stored in user-mode memory space.

Further, there are three methods for generating the software profile. The first generating module adapted to record modification of a system during installation with the help of a capturing tool, and generate the software profile according to the modification; or

The second generating module adapted to take snapshots of the system before and after the software is installed, compare differences between the snapshots, and generate the software profile according to the difference; or

The third generating module adapted to extract data from a Microsoft installation (MSI) file, and generate the software profile.

The generating unit generates the software profile and the migrating unit finishes the software migration according to the software profile, so the above software migration apparatus better realizes that the software on old computers or external storage devices can be migrated to new computers or external storage devices when the old computers or external storage devices will be replaced or eliminated, which avoids the expense for purchasing new software and brings convenience to users because the software needs not to be installed.

Though the objectives, technical schemes, and beneficial effects of the present invention have been disclosed above by exemplary embodiments, the present invention is not limited to these. Any modifications, equivalent substitutions, and variations made within the scope of the present invention fall within the scope of the present invention.

What is claimed is:

1. A method of software migration, comprising:
generating software profile, wherein the software profile comprises file layout, registry information and environment variable settings;
copying the file layout to corresponding folders, setting the registry information and the environment variable settings according to the software profile, so as to achieve software migration.

2. The method of software migration according to claim 1, further comprising:
loading an adapter on an operating system, wherein the adapter is connected to a virtual environment, and the adapter and the virtual environment are stored in user-mode memory space.

3. The method of software migration according to claim 1, wherein the steps of generating software profile comprises:
recording modification of a system during installation with the help of a capturing tool, and generating the software profile according to the modification; or
taking snapshots of the system before and after the software is installed, comparing differences between the snapshots, and generating the software profile according to the differences; or
extracting data from a Microsoft installation(MSI) file and generating the software profile.

4. The method of software migration according to claim 2, wherein the steps of generating software profile comprises:
recording modification of a system during installation with the help of a capturing tool, and generating the software profile according to the modification; or
taking snapshots of the system before and after the software is installed, comparing differences between the snapshots, and generating the software profile according to the differences; or
extracting data from a Microsoft installation(MSI) file and generating the software profile.

5. An apparatus of software migration, comprising:
a generating unit adapted to generate software profile, the software profile comprises file layout, registry information and environment variable settings;
a migrating unit adapted to copy the file layout to corresponding folders, set the registry information and the environment variable settings according to the software profile, so as to achieve software migration.

6. The apparatus of software migration according to claim 4, further comprising:
a setting unit adapted to load an adapter on an operating system, wherein the adapter is connected to a virtual environment, and the adapter and the virtual environment are stored in user-mode memory space memory space.

7. The apparatus of software migration according to claim 4, wherein the generating unit comprises:
a first generating module adapted to record modification of a system during installation with the help of a capturing tool, and generate the software profile according to the modification; or
a second generating module adapted to take snapshots of the system before and after the software is installed, compare differences between the snapshots, and generate the software profile according to the differences; or
a third generating module adapted to extract data from a Microsoft installation (MSI) file, and generate the software profile.

8. The apparatus of software migration according to claim 5, wherein the generating unit comprises:
a first generating module adapted to record modification of a system during installation with the help of a capturing tool, and generate the software profile according to the modification; or
a second generating module adapted to take snapshots of the system before and after the software is installed, compare differences between the snapshots, and generate the software profile according to the differences; or
a third generating module adapted to extract data from a Microsoft installation (MSI) file, and generate the software profile.
